(19) United States
(12) Patent Application Publication
(10) Pub. No.: US 2007/0022860 A1
(43) Pub. Date: Feb. 1, 2007

(54) Apparatus for slicing vegetable or fruit

(76) Inventor: Johnny Yim Chow, Long N.T. (HK)

Correspondence Address: J C PATENTS, INC., 4 VENTURE, SUITE 250, IRVINE, CA, 92618, US

(21) Appl. No.: 10/575,046

(22) PCT Filed: Oct. 10, 2004
(86) PCT No.: PCT/CN04/01147

§ 371 Date: Apr. 3, 2006

(51) Int. Cl. B26D 1/00

(52) U.S. Cl. 83/651

(57) ABSTRACT

A fruit/vegetable slicer for slicing the food stuff, wherein it comprises: a stand suitable to be installed at the bottom to support the upper composite parts, comprising a rotational crank, a movable blade frame and a housing, wherein a food stuff pressing plate is inserted in the through hole of the housing. In order to slice the fruits and vegetables, firstly the food stuff pressing plate is taken out and the food stuff is put into the housing through hole, the food stuff is constantly being pressed down and the rotational crank is continually being rotated, when the rotational crank rotates clockwise, the movable blade frame reciprocatingly moves laterally such that the food being pressed stuff is sliced. The fruit/vegetable slicer can be operated very easily, and the pressed food stuff can be sliced by merely rotating the rotational crank clockwise and slightly pressing the food stuff pressing plate. Thus the fruits and vegetables can be sliced steadily, swiftly and conveniently, without the user's being in immediate contact with the blade or causing any unnecessary danger.

### BACKGROUND OF THE INVENTION

1. Field of the Invention

This invention relates to a fruit/vegetable slicer, and particularly, to a fruit/vegetable slicer for slicing food stuff.

2. Description of the Background Art

To make dishes such as salads with the existing kitchenware, tools for slicing fruits and vegetables are needed. In the existing technology, the following three types of tools alone are applied to the operation of slicing fruits and vegetables. Among them, the first type is through reciprocating sawing action (lateral movement) of a horizontally-installed blade such that fruits and vegetables placed in between are sliced from the left to the right to achieve the slicing effect; however, it will be especially dangerous if this apparatus is applied to fruits and vegetables too soft or too small in volume, such as tomatoes or kiwi fruits, therefore, it will not and cannot be used to slice tomatoes or kiwi fruits.

Besides that, another design is an old-fashioned slicing auxiliary clip, and the method applied to this apparatus is through clipping food stuff in between, and since the shape of the clipping ends is like a comb, the fruits and vegetables can be sliced with a knife after they are clipped; however, this apparatus is not automated enough and thus it cannot save time, besides since it essentially requires the blade and human labor, the danger of it still exists.

The third design is a toothed bladed knife, this apparatus slices food stuff with a toothed bladed knife which is connected with a handle, and its toothed bladed knife consists of several parallel toothed cutting blades, and the method applied is slicing the food stuff which is placed flatwise by pushing down the apparatus; however, since food stuff is apt to roll on the table while being sliced, the apparatus brings about inconvenience and the exposed toothed blades are dangerous.

### SUMMARY OF THE INVENTION

The present invention is directed to the aforesaid problems, and an object of the present invention is to provide a novel fruit/vegetable slicer which can slice fruits and vegetables steadily, swiftly and conveniently without the risk of direct contact with the blade.

To achieve the aforesaid object, the present invention provides a fruit/vegetable slicer for slicing food stuff, characterized in that it comprises a stand disposed at the bottom; a rotational crank rotatably installed on an end of the top of the stand, wherein said rotational crank comprises an eccentric cylindrical push rod and a handle; a movable blade frame slidably installed on the stand, wherein said movable blade frame has a plurality of blades, and the end of the movable blade frame is operably connected with the rotational crank, and when the rotational crank rotates, the movable blade frame is reciprocatingly moved; a housing fixed on the upper portion of the stand, wherein the housing has a through hole for putting the food stuff to be sliced from the above; and a food stuff pressing plate inserted in the through hole of the housing.

In the aforesaid fruit/vegetable slicer, there are two rectangular groove-shaped lower wheel shaft tracks respectively disposed at the front and the back on both sides of said stand, and a plastic shaft support in the shape of a quarter-circle extends from the end of the top of the stand, a half-circle shaped lower rotational crank shaft groove is disposed respectively on both sides of the plastic shaft support, and there is a rectangular slidable lockhole disposed at the end of the plastic shaft support, and a cuboid slidable lock is mounted at the center of the lockhole. In the aforesaid fruit/vegetable slicer, a cylindrical push rod body is disposed at the central part of the eccentric cylindrical push rod of the rotational crank, and push rod shafts are disposed on the two side portions at the axes of the rotational crank, and the two shafts are joined together through a long plastic block and are located at different axes.

In the aforesaid fruit/vegetable slicer, said blade frame has a rectangular blade frame body and a reverse U-shaped fork, a rectangular plastic frame is disposed on the exterior of said blade frame body, and two circular rolling wheels are disposed respectively at the front and the back on both sides of the plastic frame, and the plurality of blades at the central part of the plastic frame are toothed blades.

In the aforesaid fruit/vegetable slicer, said housing is rectangular in shape, and it can be engaged with the surface of said stand, and a big, square through hole of the housing is disposed at the center, and the front and back edges at its bottom are both wavy edges, meanwhile, two in-hole projection tracks are disposed at the central positions on both sides, and at the central positions of the surface of the housing, there is a depressed housing pressing plate engaging recessed stripe disposed respectively on both the left and the right sides, and two rectangular groove-shaped upper wheel shaft tracks are disposed respectively at the front and the back on both sides of the housing, in addition, a quarter circle shaped mechanism extends likewise from its end, on both sides of which there disposed an upper rotational crank shaft groove in the shape of a half circle groove, and at the end of the quarter-circle shaped mechanism there is a protruding barb of the slidable lock.

In the aforesaid fruit/vegetable slicer, said food stuff pressing plate has a square shape which is engaged with the through hole of said housing, while at the central positions of the surface of the housing, there is a depressed housing pressing plate engaging recessed stripe disposed respectively on both the left and the right sides, and an array of reverse V-shaped plastic pieces are disposed at its bottom, meanwhile, a depressed pressing plate recessed track is disposed at the central positions on both sides of the array of the drooping reverse V-shaped plastic pieces.

Fruits and vegetables can be steadily, swiftly and conveniently sliced using the novel fruit/vegetable slicer in the present invention, without the risk of direct contact with the blade.

### BRIEF DESCRIPTION OF THE DRAWINGS

FIG. 1 is a perspective view of the fruit/vegetable slicer in the present invention;

FIG. 2 is an exploded perspective view of the fruit/vegetable slicer as shown in FIG. 1;

FIG. 3 is a plan perspective view of the housing as shown in FIG. 2;

FIG. 4 is a bottom perspective view of the housing as shown in FIG. 3;

FIGS. 5(1)-5(5) are flow charts of the operation of the fruit/vegetable slicer in the present invention;

FIG. 6 is an illustration diagram of the operational principle of the fruit/vegetable slicer in the present invention.

### DETAILED DESCRIPTION OF THE INVENTION

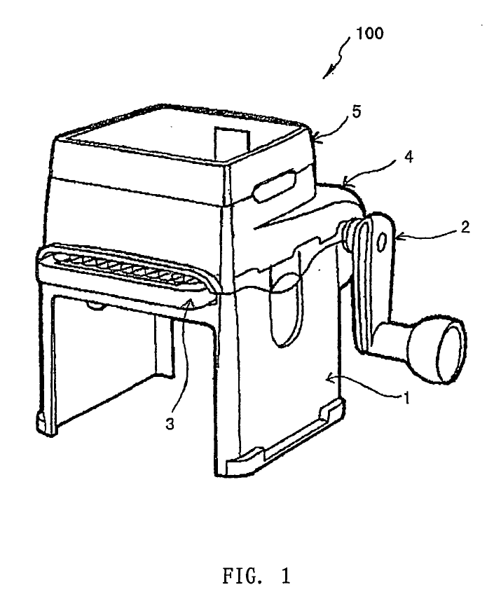

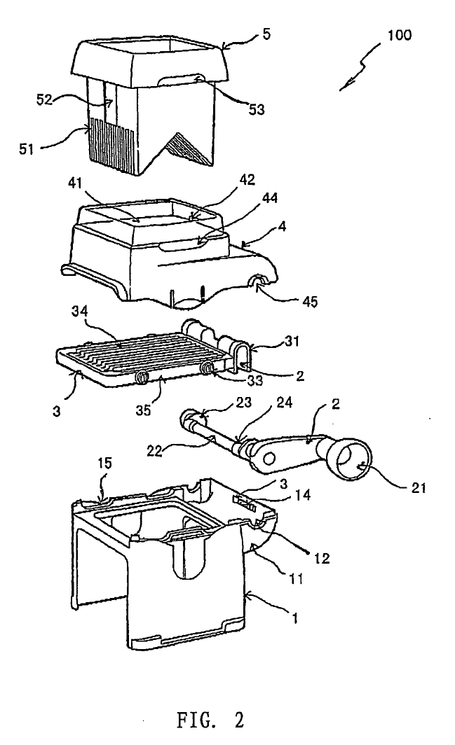

Firstly, referring to FIGS. 1 and 2, the figures show a fruit/vegetable slicer 100 of the present invention, comprising a stand 1 disposed at the bottom; a rotational crank 2 rotatably installed on a lower rotational crank shaft groove 12 on an end of the top of the stand 1; a movable blade frame 3 slidably installed on the stand 1; a housing 4 fixed on the upper portion of the stand 1; and a food stuff pressing plate 5 inserted in a through hole 41 of the housing.

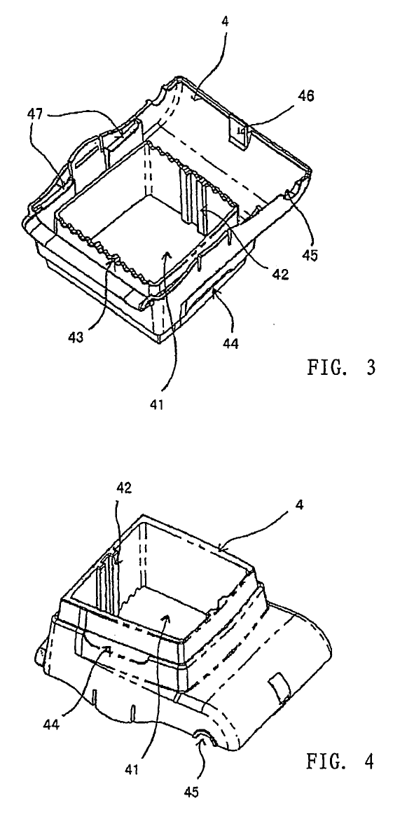

FIG. 2 is a resolution of the three-dimensional diagrammatic view of the fruit/vegetable slicer 100 in the present invention, and the figure illustrates the arrangement of the aforesaid five parts. FIGS. 3 and 4 illustrate the plan three-dimensional view and the bottom three-dimensional view of the housing 4.

The stand 1 is installed at the bottom of the fruit/vegetable slicer, there are two rectangular grooves disposed respectively at the front and the back on both sides of said stand 1, which are called lower wheel shaft tracks 15, and a plastic shaft support 11 in the shape of an arc extends from the end of the stand 1, a half-circle shaped groove is disposed respectively on both sides of the plastic shaft support 11, which is called a lower rotational crank shaft groove 12, and there is a rectangular through hole disposed at the endmost of the whole stand 1, which is called a slidable lockhole, and a slidable lock 14 is mounted at the center of the lockhole for ensuring the firm fastening between the stand 1 and the housing 4.

A rotational crank 2 is mounted on the lower rotational crank shaft groove 12 of the stand 1, and the rotational crank 2 consists of a cylindrical eccentric cylindrical push rod 24 and a handle 21, the central part of the eccentric cylindrical push rod 24 is composed of a cylindrical plastic column, which is called a push rod body 22, in addition, the two side portions are two small columns disposed at the axes of the push rod, which are called push rod shafts 23, and they are used to drive the movable blade frame 3 while the user rotates the rotational crank 2 such that it reciprocates the left-to-right movement to cut the passing food stuff.

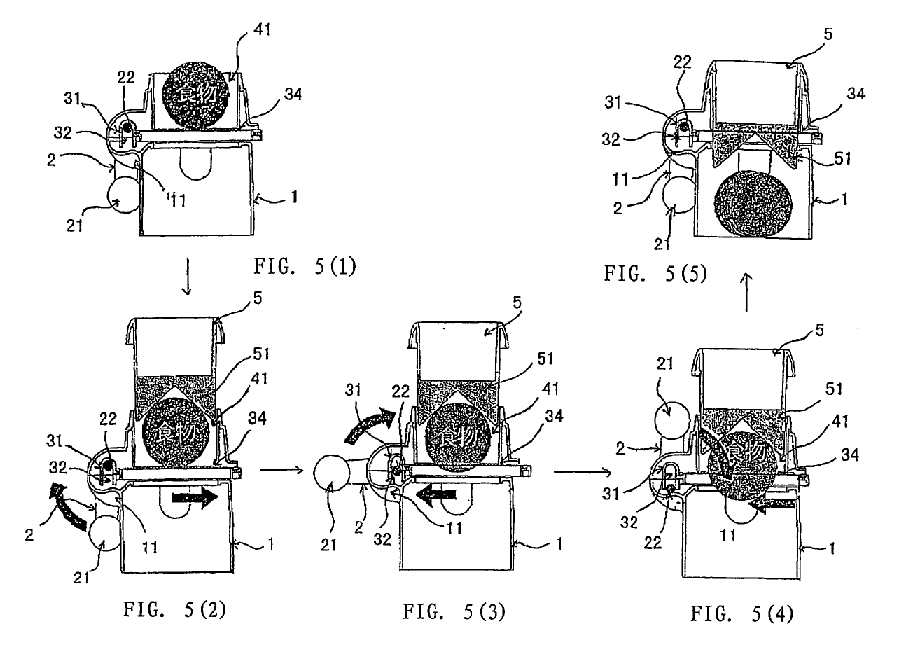

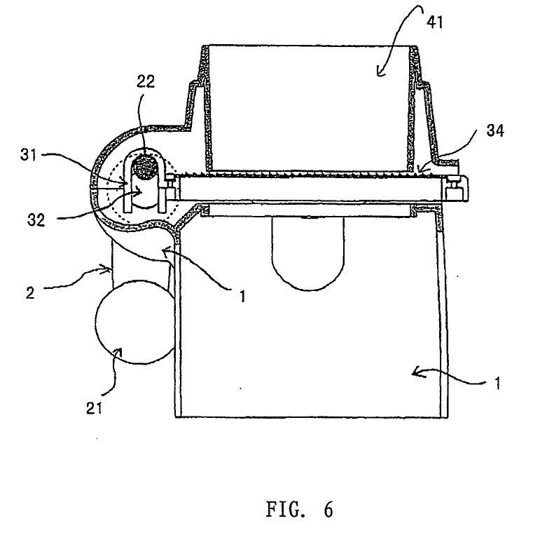

A movable blade frame 3 slidably mounted on the stand 1, said blade frame 3 consists of a rectangular blade frame body 35 and a reverse U-shaped fork 31, a rectangular plastic frame is disposed at the exterior of the blade frame body 35, two circular rolling wheels 33 are disposed respectively at the front and the back on both sides of the plastic frame, after they are assembled, they are positioned right on the lower wheel shaft tracks 15. The movable blade frame 3 is enabled to make left-to-right movement successfully, and at the central part of the plastic frame there disposed a plurality of toothed blades 34 which are used for cutting the passing food stuff, in addition, the reverse U-shaped fork 31 is positioned inside the plastic shaft support 11, meanwhile, the reverse U-shaped fork hole 32 at the center sheathes the push rod body 22, and thus the eccentric cylindrical push rod 24 performs its function of making the push rod body 22 rotates about the push rod shaft 23 as its axis on a circular track, and since the movable blade frame 3 can only move in the horizontal direction, the movement of the push rod body 22 inside the reverse U-shaped fork hole 32, on the one hand drives the movable blade frame 3 to reciprocate left-to-right movement in the horizontal direction, and on the other hand, is an up-down movement inside the hole (depicted in detail in the following text on the operation of the present invention with reference to FIGS. 5 and 6).

A housing 4 is fixed on the stand 1, and its rectangular shape is engaged with the surface of the stand 1, there is a square through hole at its center, which looks like a big chimney and is called a housing through hole 41, the front and back edges at its bottom are both wavy edges, which are called wavy edges 43 (see FIGS. 3 and 4), the protruding parts of the wavy edges 43 go right through the positions between the plurality of toothed blades 34, meanwhile, two projection stripes are disposed respectively at the central positions of both sides, which are called in-hole projection tracks 42, while a recessed stripe is disposed respectively at the central positions on both the left and the right sides of the surface of the housing 4, which is called lower housing pressing plate engaging recessed stripe 44, since the housing 4 and the surface of the stand 1 engage with each other, there are two rectangular grooves respectively disposed at the front and the back on both sides of the housing which are called upper wheel shaft tracks 47 (as shown in FIGS. 3 and 4), and which form a track with the lower shaft tracks 15 allowing the circular rolling wheels 33 to move in between, in addition, a quarter circle shaped mechanism extends likewise from its end, on both sides of which there disposed a half circle-shaped groove, which is called an over shaft groove 45 of the rotational crank, such that the upper rotational crank shaft grooves 45 form a hole called rotational crank shaft hole with the lower rotational crank shaft grooves 12 disposed on the stand 1, and at the end of the quarter-circle shaped mechanism, i.e. at the endmost of the whole housing 4 there is a protruding barb which is called a slidable lock barb 46 (as shown in FIGS. 3 and 4), the slidable lock barb 46 hooks a slidable lock hole 13 to fasten it firmly.

A food stuff pressing plate 5 is inserted into the housing through hole 41 and the square shape of the plate and the housing through hole 41 engage with each other, while at the central positions of the surface of the housing 4, there is a recessed stripe disposed respectively on both the left and the right sides, which is called upper housing pressing plate engaging recessed stripe 53, which makes it easier for the user to take the food stuff pressing plate 5 out, an array of reverse V-shaped plastic pieces 51 are disposed at its bottom which pass right through the gaps between the plurality of toothed blades 34 on the movable blade frame 3, meanwhile, a recessed surface is disposed at the central positions on both sides of the array of the drooping reverse V-shaped plastic pieces 51, which are called pressing plate recessed tracks 52, the pressing plate recessed tracks 52 and the inside-hole projection tracks 42 engage with each other, which makes it more steady when the food stuff pressing plate 5 presses the food stuff.

Next, referring to FIGS. 5 and 6, these figures are illustration diagrams of the operational principle of the fruit/vegetable slicer 100 in the present invention, the whole operational flow is shown in the order of (1) to (5). FIG. 5(1) shows a state when the fruit/vegetable slicer 100 begins the operation, the first step is taking the food stuff pressing plate 5 out and putting the food stuff into the housing through hole 41; FIG. 5(2) shows the condition when the fruit/vegetable slicer is ready to perform the cutting down operation, slightly pressing the food stuff pressing plate 5 down on the food stuff and rotating the rotational crank 2, the array of reverse V-shaped plastic pieces 51 of the food stuff pressing plate 5 will secure the food stuff; FIGS. 5(3) and 5(4) show the condition when the fruit/vegetable slicer 100 performs the cutting-down operation, it can be seen from the figures that the food stuff is constantly pressed down and the rotational crank 2 is continuously rotated, while the rotational crank 2 rotates clockwise, the movable blade frame 3 will move in the direction of the lateral arrowheads as shown in FIGS. 5(2) to 5(4). In the process shown in 5(2) to 5(3), the rotational crank 2 is moved by its handle 21 downward and rotates in the left direction as shown in the figures, and as shown in FIG. 6, the push rod body 22 is driven by this movement and rotates along the circular track clockwise as shown in the figure such that the reverse U-shaped fork hole 32 moves right and the whole movable blade frame 3 moves right, and in the circular track, the clockwise rotation drives the push rod body 22 move downward as it moves right, it can be seen from FIG. 5(3) that the position of the push rod body 22 in FIG. 5(3) is lower than its position in FIG. 5(2); in the processes of FIGS. 5(3) to 5(4), the rotational crank 2 is moved by its handle 21 in the left direction to the upward direction as shown in the figures, as shown in FIG. 6, the push rod body 22 is driven by this movement and will rotate clockwise along the circular track in the figures and make the reverse U-shaped fork hole 32 move left, and the whole movable blade frame 3 moves left to return to the central position of the circle, and in the circular track, clockwise rotation makes the push rod body 22 move downward as it moves left, and it can be seen that the position of the push rod body 22 inside the reverse U-shaped fork hole in FIG. 5(4) is lower than its position in FIG. 5(3); and then constantly rotating the handle 21 can drive the push rod body 22 to rotate clockwise as shown in FIG. 6 to achieve the object of reciprocatingly moving the movable blade frame 3 left-to-right to cut the passing food stuff; therefore, as shown in FIG. 5(5), the food stuff is pushed down and is sliced by reciprocatingly moving the toothed blades 34.

It can be seen from the aforesaid structure that the present invention provides a novel fruit/vegetable slicer, and thus the fruits and vegetables can be sliced steadily, swiftly and conveniently, without the user's being in immediate contact with the blade or causing any unnecessary danger.

What is claimed is:

1. A fruit/vegetable slicer for slicing the food stuff, characterized in that it comprises:
a stand disposed at the bottom;
a rotational crank rotatably installed on an end of the top of the stand, wherein said rotational crank comprises an eccentric cylindrical push rod and a handle;
a movable blade frame slidably installed on the stand, wherein said movable blade frame has a plurality of blades, and the end of the movable blade frame is operably connected with the rotational crank, and when the rotational crank rotates, the movable blade frame is reciprocatingly moved;
a housing fixed on the upper portion of the stand, wherein the housing has a through hole for putting the food stuff to be sliced from the above; and
a food stuff pressing plate inserted in the through hole of the housing.

2. The fruit/vegetable slicer of claim 1, characterized in that there are two rectangular groove-shaped lower wheel shaft tracks respectively disposed at the front and the back on either side of said stand, and a plastic shaft support in the shape of a quarter-circle extends from the end of the top of the stand, a half-circle shaped lower rotational crank shaft groove is disposed respectively on both sides of the plastic shaft support, and there is a rectangular slidable lockhole disposed at the end of the plastic shaft support, and a cuboid slidable lock is mounted at the center of the lockhole.

3. The fruit/vegetable slicer, characterized in that a cylindrical push rod body is disposed at the central part of the eccentric cylindrical push rod of the rotational crank, and push rod shafts are disposed on the two side portions at the axes of the rotational crank, and the two shafts are joined together through a long plastic block and are located at different axes.

4. The fruit/vegetable slicer of claim 1, characterized in that said blade frame has a rectangular blade frame body and a reverse U-shaped fork, a rectangular plastic frame is disposed on the exterior of said blade frame body, and two circular rolling wheels are disposed respectively at the front and the back on both sides of the plastic frame, and the plurality of blades at the central part of the plastic frame are toothed blades.

5. The fruit/vegetable slicer of claim 1, characterized in that said housing is rectangular in shape, and it can be complementarily engaged with the surface of said stand, and a big square through hole of the housing is disposed at the center thereof, and the front and back edges at its bottom are both wavy edges, meanwhile, two in-hole projection tracks are disposed at the central positions on both sides, and at the central positions of the surface of the housing, there is a depressed housing pressing plate engaging recessed stripe disposed respectively on both the left and the right sides, and two rectangular groove-shaped upper wheel shaft tracks are disposed respectively at the front and the back on both sides of the housing, in addition, a quarter circle shaped mechanism extends likewise from its end, on both sides of which there is disposed an upper rotational crank shaft groove in the shape of a half circle groove, and at the end of the quarter-circle shaped mechanism there is a protruding barb of the slidable lock.

6. The fruit/vegetable slicer of claim 1, characterized in that said food stuff pressing plate has a square shape which is complementary with the through hole of said housing, while at the central positions of the surface of the housing, there is a depressed housing pressing plate engaging recessed stripe disposed respectively on both the left and the right sides, and an array of reverse V-shaped plastic pieces are disposed at its bottom, meanwhile, a depressed pressing plate recessed track is disposed at the central positions on both sides of the array of the drooping reverse V-shaped plastic pieces.
